(19) United States
(12) Patent Application Publication
(10) Pub. No.: US 2005/0242594 A1
(43) Pub. Date: Nov. 3, 2005

(54) Spring unit with damper and opening-closing device

(75) Inventor: Masaru Arakawa, Suita-shi (JP)

Correspondence Address: HAUPTMAN KANESAKA BERNER PATENT AGENTS, SUITE 300, 1700 DIAGONAL RD, ALEXANDRIA, VA, 22314-2848, US

(73) Assignee: NIFCO INC., Yokohama-shi (JP)

(21) Appl. No.: 11/101,474

(22) Filed: Apr. 8, 2005

(30) Foreign Application Priority Data
Apr. 15, 2004 (JP) 2004-120069

(51) Int. Cl. E05F 1/08

(52) U.S. Cl. 292/327

(57) ABSTRACT

A spring unit with a damper includes a torsion coil spring having two ends portions and a wound portion between the two end portions, and a cylindrical spring member having a slit extending in a longitudinal direction and an outer diameter larger than an inner diameter of the wound portion. When the two end portions of the torsion coil spring rotates, the inner diameter is changed to generate a friction force between the torsion coil spring and the cylindrical spring member, thereby utilizing the friction force as a damping force.

### BACKGROUND OF THE INVENTION AND RELATED ART STATEMENT

The present invention relates to a spring unit with a damper, and an opening-closing device for switching a lid relative to a main body.

In an opening-closing device of a rotary lid, a spring urges an opening-closing body such as a rotary lid toward an opening position. When the rotary lid is released from a closed position, the rotary lid is switched toward the opening position with the spring. As the spring, a torsion spring is used to accumulate a maximum force at the closed position of the rotary lid in a case that the rotary lid is switched toward the opening position from the closed position with the spring.

Conventionally, an oil damper is provided for damping a rotational speed of an opening-closing body, so that the opening-closing body rotates smoothly. When it is difficult to provide an oil damper due to cost limitation, a cushion may be provided near a closed position of the opening-closing body, thereby preventing the opening-closing body from bouncing. Instead of the cushion, Patent Reference 1 has disclosed a structure, in which a rotational shaft is provided inside a torsion spring, and a friction member is disposed in a cut portion of the rotational shaft. In the structure, when an opening-closing body rotates, the torsion spring rotates together with the opening-closing body. Accordingly, an inner diameter of a wound portion of the torsion spring is reduced with the rotation of an end portion of the torsion spring, so that the wound portion presses the friction member against the rotational shaft, thereby utilizing a pressing force and a frictional force as a damping force.

Patent Reference 1: Japanese Patent Publication (Kokoku) No. 02-52753.

The opening-closing device disclosed in the storage device 1 has the structure in which the friction member is attached to a part of the rotational shaft. Accordingly, the friction member tends to wear easily, thereby making the damping force unstable in a relatively early stage and making it difficult to maintain the original damping force for long time.

In view of the problems described above, an object of the present invention is provide an opening-closing device with a simple structure, in which it is possible to maintain an original damping force for long time, and it is easy to obtain a desirable damping force.

Further objects and advantages of the invention will be apparent from the following description of the invention.

### SUMMARY OF THE INVENTION

According to a first aspect of the present invention, a spring unit with a damper includes a torsion coil spring having two ends portions and a wound portion between the two end portions, and a cylindrical spring member with a C-shape cross section having a slit extending in a longitudinal direction and an outer diameter larger than an inner diameter of the wound portion. When the two end portions of the torsion coil spring rotates, the inner diameter is changed to generate a friction force between the torsion coil spring and the cylindrical spring member, thereby utilizing the friction force as a damping force.

According to a second aspect of the present invention, a spring unit with a damper may include an intermediate material such as oil disposed between the wound portion and the cylindrical spring member.

According to a third aspect of the present invention, an opening-closing device switches an opening-closing body relative to a main body. The opening-closing body is rotatably attached to the main body. The opening-closing device includes a spring unit formed of a torsion coil spring having two ends portions and a wound portion between the two end portions. One of the two end portions is fixed to the opening-closing body, and the other of the two end portions is fixed to the main body. The torsion coil spring switches the opening-closing body toward one of an open position and a closed position. The spring unit further includes a cylindrical spring member with a C-shape cross section having a slit extending in a longitudinal direction and an outer diameter larger than an inner diameter of the wound portion. When the two end portions of the torsion coil spring rotates, the inner diameter is changed to generate a friction force between the torsion coil spring and the cylindrical spring member, thereby utilizing the friction force as a damping force.

According to a fourth aspect of the present invention, in the opening-closing device, in a case that the spring unit urges the opening-closing body toward the open position from the closed position, it is preferred that the wound portion has an inner diameter at the open position larger than that in an original state of the torsion coil spring (before being attached to the opening-closing body). Further, it is preferred that the inner diameter increases when the opening-closing body rotates to the closed position from the open position.

In the present invention, when the torsion coil spring rotates in a direction that the wound portion is further wound with the one end, the inner diameter thereof is reduced and presses the cylindrical spring member to generate the friction force. At this time, the cylindrical spring member deforms such that the slit is narrowed, thereby absorbing the friction force to some extent. On the other hand, when the torsion coil spring rotates in an opposite direction that the wound portion is unwound with the one end, the friction force relative to the cylindrical spring member is reduced. At this time, the cylindrical spring member deforms such that the slit is expanded, thereby maintaining the friction force at an appropriate level. Accordingly, with the structure of the present invention, even if the wound portion or the cylindrical spring member wears, it is possible to finely adjust torque through restoration of the wound portion and the cylindrical spring member, thereby maintaining the damping force constant without a variance in the damping force due to the wear.

In the present invention, it is possible to obtain the following advantages. In the first aspect, the cylindrical spring member has the C-shape cross section and the outer diameter larger than the inner diameter of the wound portion. The cylindrical spring member is fitted into the wound portion of the torsion coil spring. Accordingly, it is possible to adjust variance in the damping force due to the wear of the wound portion and the cylindrical spring member with the restoration force of the cylindrical spring member, thereby reducing the variance and obtaining a stable operation.

In the second aspect, the intermediate material such as oil is disposed between the wound portion and the cylindrical spring member, thereby stabilizing and adjusting the damping force.

In the third aspect, it is possible to make the opening-closing device simple and stably damp a rotational speed of the opening-closing body for long time. Further, it is possible to change the damping force according to the rotational direction of the opening-closing body. It is possible to form the spring unit with the torsion coil spring and the cylindrical spring member, thereby making the structure simple and reducing cost.

In the fourth aspect, in a case that the spring unit urges the opening-closing body toward the open position from the closed position, it is possible to increase the damping force or the friction force when the opening-closing body rotates to the open position from the closed position. And, it is possible to reduce the damping force or the friction force when the opening-closing body rotates to the closed position from the open position, thereby obtaining a proper switching operation.

### BRIEF DESCRIPTION OF THE DRAWINGS

FIGS. 1(a) and 1(b) are views showing a spring unit with a damper according to an embodiment of the present invention, wherein FIG. 1(a) is a perspective view thereof, and FIG. 1(b) is an exploded view thereof;

FIGS. 2 (a) to 2(c) are views showing the spring unit and components thereof, wherein FIG. 2(a) is a side view of the spring unit, FIG. 2(b) is a side view of a torsion coil spring, and FIG. 2(c) is a side view of a cylindrical spring member;

FIG. 3 is an exploded perspective view of an electric device having an opening-closing device according to an embodiment of the present invention;

FIG. 4(a) is a plan view of the electric device, and FIG. 4(b) is a side view of the electric device; and

FIG. 5(a) is a plan view of an essential part of the electric device, and FIG. 5(b) is a side view of an essential part of the electric device.

### DETAILED DESCRIPTION OF PREFERRED EMBODIMENTS

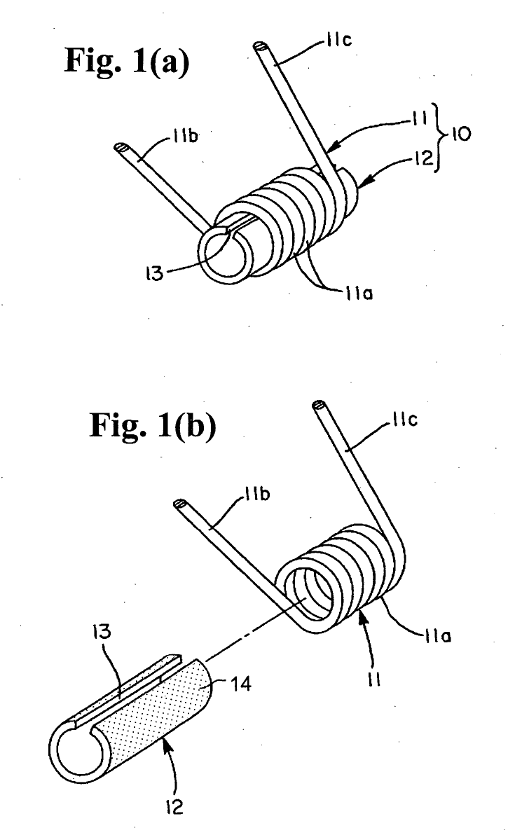

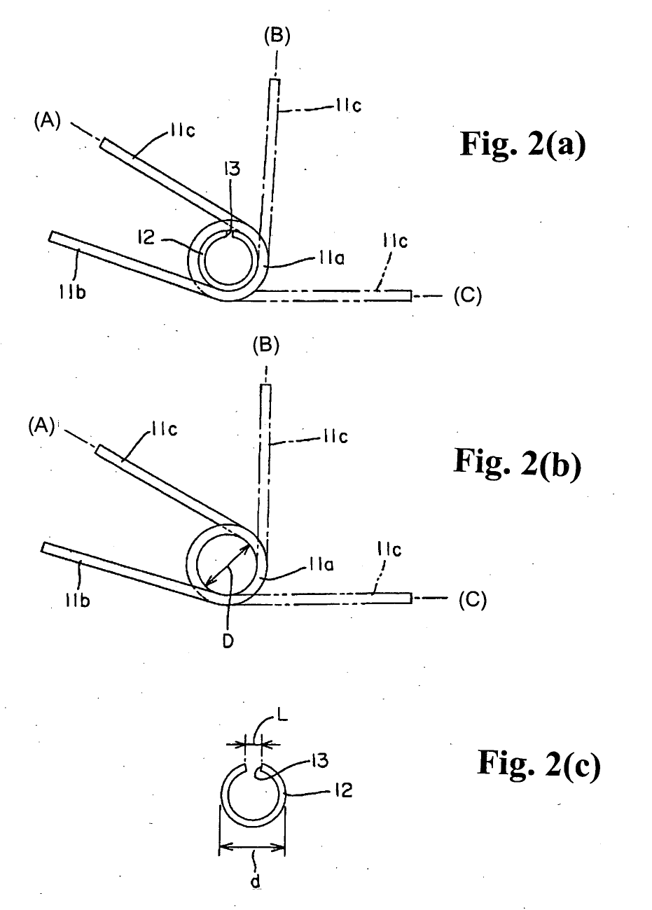

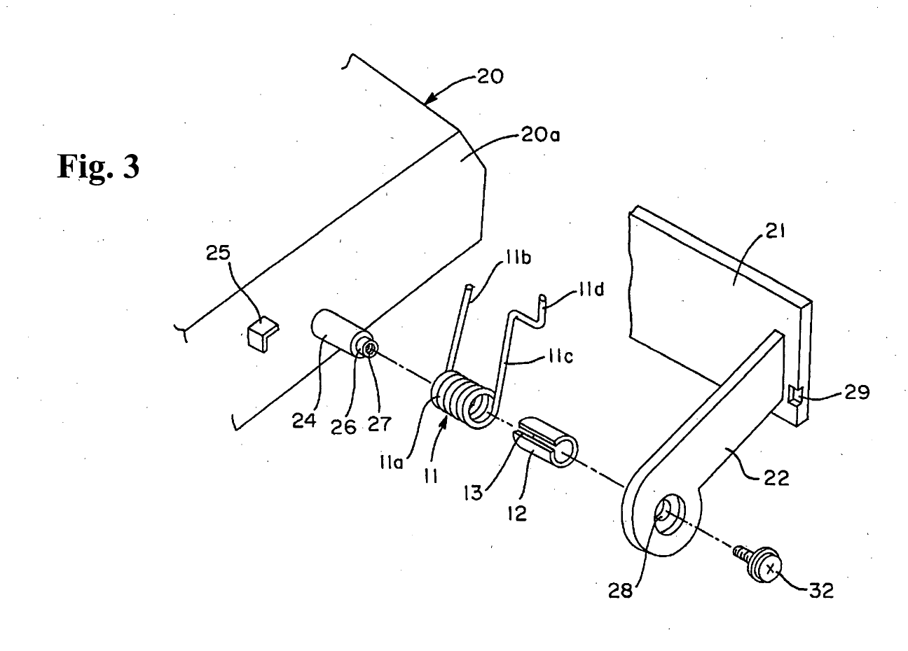

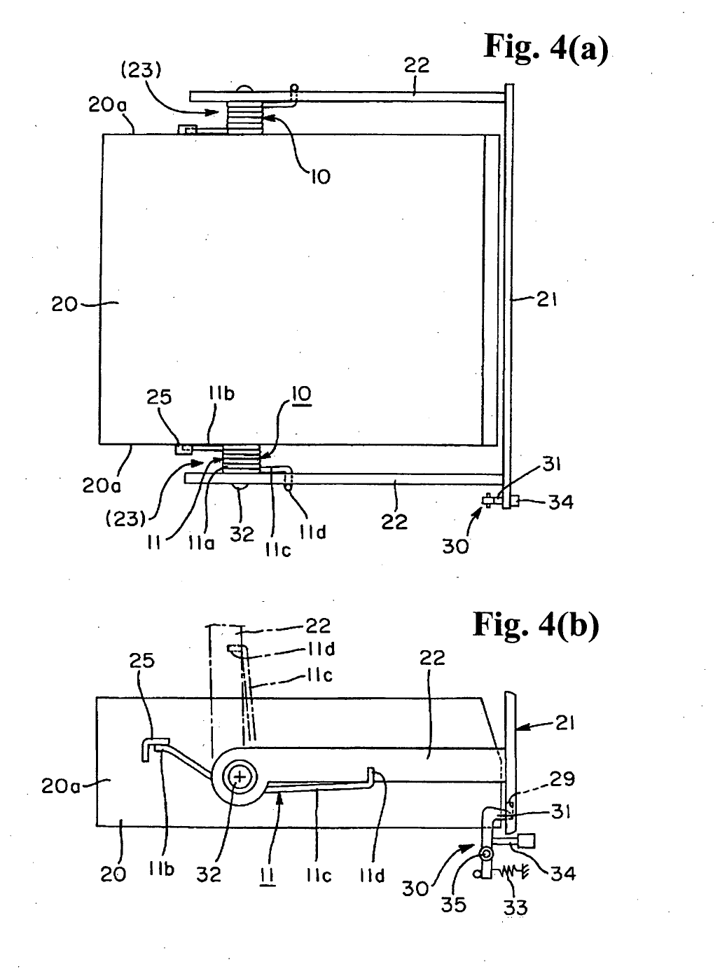

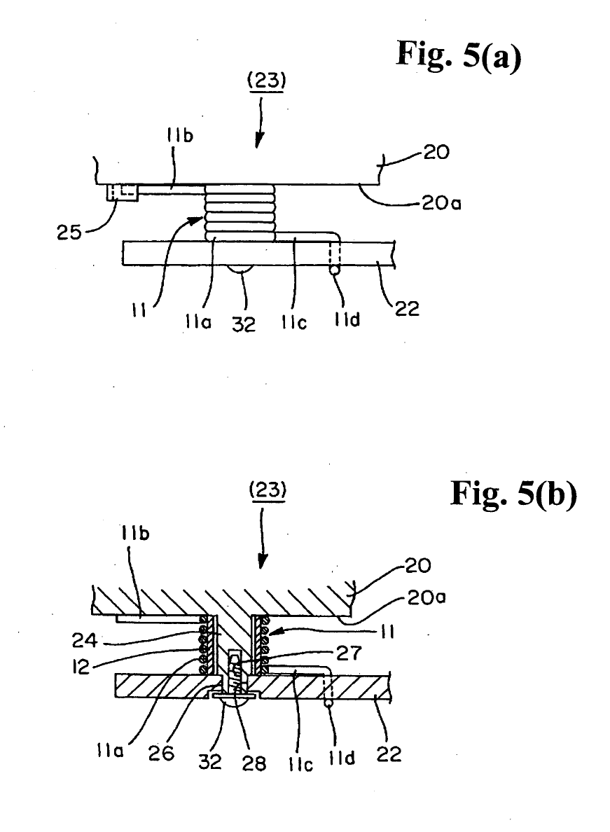

Hereunder, embodiments of the present invention will be explained with reference to the accompanying drawings. FIGS. 1(a) and 1(b) are views showing a spring unit with a damper according to an embodiment of the present invention, wherein FIG. 1(a) is a perspective view thereof, and FIG. 1(b) is an exploded view thereof. FIGS. 2(a) to 2(c) are views showing the spring unit and components thereof, wherein FIG. 2(a) is a side view of the spring unit, FIG. 2(b) is a side view of a torsion coil spring, and FIG. 2(c) is a side view of a cylindrical spring member. FIG. 3 is an exploded view of an electric device having an opening-closing device according to an embodiment of the present invention. FIG. 4(a) is a plan view of the electric device, and FIG. 4(b) is a side view of the electric device. FIG. 5(a) is a plan view of an essential part of the electric device, and FIG. 5(b) is a side view of an essential part of the electric device. Detailed explanations in the order of the spring unit, and the opening-closing device will follow.

(Spring Unit)

In FIGS. 1(a) and 1(b) to 2(a)-2(c), a spring unit 10 is formed of a torsion coil spring 11 made of a wire and a cylindrical spring member 12 made of steel or plastic. The torsion coil spring 11 has a wound portion 11a wound in a circle, and two end portions 11b and 11c of the wound portion 11a extending in a same direction. When the torsion coil spring 11 is rotated in a clockwise direction from a position indicated by a solid line in FIG. 2(b) in a state that the one end portion 11b is fixed, the wound portion 11a is unwound to expand an inner diameter D while accumulating a restoration force. When a force applied on the other end portion 11c is released, the torsion coil spring 11 is restored to an original shape with the restoration force, i.e., the wound portion 11a is wound to contract the inner diameter D.

In FIG. 2(b), when the torsion coil spring 11 rotates, the other end portion 11c moves relative to the one end portion 11b from an initial position (A) to an open position (B) to a closed position (C). When the other end portion 11c is located at the initial position (A), the inner diameter D is D0. When the other end portion 11c is located at the open position (B), the inner diameter D is D1. When the other end portion 11c is located at the closed position (C), the inner diameter D is D2. In this case, D0 is smaller than D1, and D1 is smaller than D2.

The cylindrical spring member 12 is made of plastic with die molding, or made of steel through rolling a metal plate into a cylindrical shape. The cylindrical spring member 12 has a gap (slit 13) between two ends thereof, so that a cross section thereof becomes a C shape. The cylindrical spring member 12 has a length same or greater than that of the wound portion 11a in an axial direction thereof. The cylindrical spring member 12 has an outer diameter d (an outer diameter when the cylindrical spring member 12 is not disposed in the wound portion 11a) greater than the inner diameter D2 of the wound portion 11a at the closed position (C). That is, the outer diameter d is greater than D2, D2 is greater than D1, and D1 is greater than D0.

A process of assembling the cylindrical spring member 12 into the torsion coil spring 11 will be explained next. The other end portion 11b of the torsion coil spring 11 is fixed, and the torsion coil spring 11 is rotated in a direction that the wound portion 11a is unwound beyond the closed position (C) until the inner diameter D of the wound portion 11a becomes greater than the outer diameter d of the cylindrical spring member 12. In this state, the cylindrical spring member 12 is inserted into the torsion coil spring 11, and then the force applied to the other end portion 11c for rotating the torsion coil spring 11 is released. Accordingly, the other end portion 11c rotates in an opposite direction, i.e., toward the original position (A), with the restoration force, and the inner diameter of the wound portion 11a is contracted, thereby pressing the wound portion 11a against an outer surface of the cylindrical spring member 12.

The outer diameter d of the cylindrical spring member 12 is contracted with the pressing force. That is, the outer diameter d becomes the same as the inner diameter D2 of the wound portion 11a 2 at the closed position (C), the same as the inner diameter D1 of the wound portion 11a at the open position (B), and the same as the inner diameter D0 of the wound portion 11a at the original position (C). Accordingly, the cylindrical spring member 12 is assembled into the torsion coil spring 11 while always having a restoration force against the torsion coil spring 11, thereby integrating the cylindrical spring member 12 and the torsion coil spring 11 as the spring unit 10. The cylindrical spring member 12 and the torsion coil spring 11 operate as the spring unit 10 afterward.

As shown in FIG. 2(a), the one end portion 11b of the torsion coil spring 11 is fixed, and the other end portion 11c is rotated to the closed position (C) opposite to the open position (B) in the direction that the torsion coil spring 11 is wound. Then, from the state that the wound portion 11a is unwound, the other end portion 11c is rotated toward the open position (B), i.e., in the direction that the wound portion 11a is wound, with the restoration force. Accordingly, the wound portion 11a is wound and rotated relative to the cylindrical spring member 12 while contracting the inner diameter thereof with the rotation of the other end portion 11c.

When the wound portion 11a is rotated, an inner surface of the wound portion 11a is pressed against the outer surface of the cylindrical spring member 12. The pressing force becomes a load against the rotation of the wound portion 11a, i.e., a damping force, thereby generating a damping effect. When the other end portion 11c is rotated from the open position (B) to the closed position (C), the wound portion 11a is unwound, thereby rotating the other end portion 11c toward the closed position (C) while reducing the frictional force between the wound portion 11a and the cylindrical spring member 12.

In the spring unit 10, the frictional force is always generated between the torsion coil spring 11 and the cylindrical spring member 12 with the restoration force. When the one end portion 11b of the torsion coil spring 11 is fixed, and the other end portion 11c is rotated in the one direction from the closed position (C) to the open position (B), the wound portion 11a is wound, thereby increasing the damping force. When the other end portion 11c is rotated from the open position (B) to the closed position (C), the wound portion 11a is unwound, thereby reducing the damping force.

The cylindrical spring member 12 is assembled into the torsion coil spring 11 in a state that the outer diameter thereof is contracted with the slit 13 to accumulate the restoration force. Accordingly, even when the wound portion 11a and the cylindrical spring member 12 wear, it is possible to finely adjust torque with the restoration force, thereby maintaining the original damping force for long time.

It is possible to adjust the damping force through adjusting the length and wound diameter of the wound portion 11a, the material, length, outer diameter of the cylindrical spring member 12, and the width of the slit 13. It is possible to dispose a member 14 for adjusting the damping force such as oil between the wound portion 11a and the cylindrical spring member 12, thereby making it possible to adjust the damping force.

(Opening-Closing Device)

FIGS. 3, 4(a)-4(b) and 5(a)-5(b) are views showing an opening-closing device 23 provided with the spring unit 10 described above. An opening-closing body 21 is rotatably attached to a main body 20 of the device through support shafts 24. The opening-closing body 21 can be switched toward an open position or a closed position with the urging force of the torsion coil spring 11 of the spring unit 10. In this embodiment, the opening-closing body 21 can be switched to automatically rotate from the closed position to the open position with the urging force of the torsion coil spring 11.

The main body 20 has two side surfaces 20a including the supporting shafts 24 with a cylindrical shape protruding from the side surfaces 20a and spring fixing portions 25 disposed away from the supporting shafts 24. The supporting shafts 24 have an outer diameter smaller than the inner diameter d of the cylindrical spring member 12, so that the cylindrical spring member 12 of the spring unit 10 does not interfere with the spring contraction. The supporting shafts 24 have small diameter shafts 26, and the small diameter shafts 26 have screw holes 27 at tip surfaces thereof. The supporting shafts 24 have a length (not including the small diameter shafts 26) substantially equal to that of the wound portion 11a of the torsion spring coil 11 of the spring unit 10, or that of the cylindrical spring member 12.

The opening-closing body 21 is a lid for covering a front surface of the main body 20, and has arms 22 protruding from an inner side surface thereof at both sides. Each of the arms 22 has a shaft hole 28 at a tip portion thereof. An engagement recess 29 is formed in the opening-closing body 21 corresponding to a latch device 30 formed on the main body 20. The device latch 30 is supported on a shaft 35, and has a latch member 31 urged in one direction with a spring member 33 and an operation member 34 for switching the latch member 31 from an engagement position where the latch member 31 engages the engaging recess 29 and an engagement released position.

A process of assembling the opening-closing body 21 to the main body through the opening-closing device 23 will be explained next. The spring unit 10 includes the torsion coil spring 11 having a hooking portion lid formed in an L shape at the other end portion 11c. In assembling, the cylindrical spring member 12 integrated with the torsion coil spring 11 corresponds to the supporting shaft 24, so that the supporting shaft 24 is inserted into the cylindrical spring member 12, thereby engaging the one end portion 11b of the torsion coil spring 11 with a lower portion of the spring fixing portion 25.

The small diameter shaft 26 of the supporting shaft 24 protruding from the wound portion 11a is inserted into the shaft hole 28 of the arm 22, so that the arm 22 of the opening-closing body 21 is attached to the supporting shaft 24. At this time, the hooking portion 11d of the torsion coil spring 11 engages a lower portion of the arm 22. In this state, a fixing member such as a bolt 32 is screwed in the screw hole 27 of the small diameter shaft 26 through the shaft hole 28 of the arm 22, thereby completing the assembly of the opening-closing body 21.

In the opening-closing device described above, when the opening-closing body 21 is rotated in the clockwise direction to the closed position where the torsion coil springs 11 are located at the closed position (C), a claw of the latch member 31 engages the engaging recess 29, thereby holding the opening-closing body 21 at the closed position. When the opening-closing body 21 is at the closed position, the wound portions 11a of the torsion coil springs 11 are unwound, thereby reducing the friction force between the wound portions 11a and the cylindrical spring members 12. The torsion coil springs 11 accumulate the restoration force for always urging the opening-closing body 21 toward the open position (B)

In a state that the opening-closing body 21 is held at the closed position, when the latch device 30 of the operation member 34 is pushed in, the latch member 31 is pushed in the disengaging direction and disengaged from the engaging recess 29. Accordingly, the opening-closing body 21 is rotated together with the other end portions 10c around the small diameter shafts 26 with the restoration force of the torsion coil springs 11 until the other end portions 11c move to the open position (B). When the other end portions 11c rotate toward the open position (B), the wound portions 11a of the torsion coil springs 11 are wound and rotated relative to the cylindrical spring members 12. In this structure, the friction force between the wound portions 11a and the cylindrical spring members 12 becomes the damping force. Accordingly, as the opening-closing body. 21 approaches the open position, the damping force becomes greater, thereby slowing the rotational speed and obtaining smooth rotation. Further, it is possible to prevent the opening-closing body 21 from bouncing.

In the opening-closing device 23 described above, it is possible to obtain the large damping force when the opening-closing body 21 rotates from the closed position to the open position. Alternatively, the damping force may be obtained when the opening-closing body 21 rotates from the open position to the closed position. The opening-closing device is applicable to a rotational switch type assist grip in a vehicle and other holding structures in addition to the box structure.

The disclosure of Japanese Patent Application No. 2004-120069, filed on Apr. 15, 2004, is incorporated in the application.

While the invention has been explained with reference to the specific embodiments of the invention, the explanation is illustrative and the invention is limited only by the appended claims.

1. A spring unit with a damper, comprising:
a torsion coil spring having two ends portions, and a wound portion between the two end portions, said wound portion having an inner diameter, and
a cylindrical spring member having a slit extending in a longitudinal direction thereof, and an outer diameter greater than the inner diameter of the wound portion, said cylindrical spring member being disposed in the wound portion in a condition that the cylindrical spring member is radially inwardly compressed.

2. A spring unit according to claim 1, wherein said cylindrical spring member is formed to contract and expand in a radial direction according to movements of the two ends to provide damping force to the ends.

3. A spring unit according to claim 2, further comprising an intermediate material disposed between the wound portion and the cylindrical spring member.

4. A spring unit according to claim 2, wherein said cylindrical spring member has a C-shape cross section.

5. A spring unit according to claim 4, wherein said cylindrical spring member has a lateral length equal to or greater than that of the wound portion.

6. An opening-closing device comprising:
a main body,
an opening-closing body rotationally attached to the main body to move to an open position or a closed position relative to the main body,
a shaft attached to one of the main body and the opening-closing body to rotationally connect the main body and the opening-closing body, and
the spring unit according to claim 1 disposed between the main body and the opening-closing body, one of said two end portions being fixed to the opening-closing body and the other of said two end portions being fixed to the main body.

7. An opening-closing device according to claim 6, wherein said wound portion has the inner diameter at the open position larger than that in an original state of the torsion coil spring, said inner diameter increasing when the opening-closing body rotates to the closed position from the open position in a case that the spring unit urges the opening-closing body toward the open position.
